(19) United States
(12) Patent Application Publication
(10) Pub. No.: US 2025/0028099 A1
(43) Pub. Date: Jan. 23, 2025

(54) OPTICAL FILM AND DISPLAY DEVICE COMPRISING SAME

(71) Applicant: KOLON INDUSTRIES, INC., Seoul (KR)

(72) Inventors: HyoKyung LEE, Seoul (KR); Hyojun PARK, Seoul (KR)

(21) Appl. No.: 18/717,066

(22) PCT Filed: Sep. 19, 2022
(86) PCT No.: PCT/KR2022/013958

§ 371 Date: Jun. 6, 2024

(30) Foreign Application Priority Data
Dec. 16, 2021 (KR) 10-2021-0180609

(51) Int. Cl. G02B 5/20; C08K 5/11; C09D 5/32; C09D 179/08

(52) U.S. Cl. CPC G02B 5/208; C09D 5/32; C09D 179/08; C08K 5/11

(57) ABSTRACT

Disclosed is an optical film including a light-transmitting substrate, the optical film having a yellowness index before a light resistance test of 5.0 or less and a color change (ΔE*_{ab}) after the light resistance test of 3.5 or less, and a display device including the same.

### TECHNICAL FIELD

The present disclosure relates to an optical film and a display device including the same.

### BACKGROUND ART

Recently, the use of an optical film including a polymer resin instead of glass as a cover window of a display device has been considered with the goal of reducing thickness and weight and increasing the flexibility of the display device. In order for the optical film to be usable as a cover window of a display device, the optical film needs to have superior optical properties and excellent mechanical properties.

Meanwhile, an optical film including a polymer resin has problems of having a high initial yellowness index or causing color change upon exposure to light over time.

Therefore, there is a need for the development of films having excellent optical properties as well as superior mechanical properties such as insolubility, chemical resistance, and heat resistance, and optical properties such as light resistance.

### DISCLOSURE

### Technical Problem

Therefore, the present disclosure has been made in view of the above problems, and it is one aspect of the present disclosure to provide an optical film that exhibits excellent light resistance.

It is another aspect of the present disclosure to provide a display device including the optical film that exhibits excellent light resistance.

### Technical Solution

In accordance with one aspect of the present disclosure, provided is an optical film including a light-transmitting substrate, the optical film having a yellowness index before a light resistance test of 5.0 or less and a color change (ΔE*_{ab}) after the light resistance test of 3.5 or less.

The light resistance test is performed under the following conditions [daylight filter, 12 kW 0.8 W/m², @420 nm, 30° C./30 RH % chamber and 55° C. black panel] using a Xenon lamp for 300 hours, and the color change (ΔE*_{ab}) is calculated by the following Equation 1:

$$Δ {E}_{ab}^{*} = {[ {( Δ {L}^{*} )}^{2} + {( Δ {a}^{*} )}^{2} + {( Δ {b}^{*} )}^{2} ]}^{1 / 2} \qquad 〈 Equation 1 〉$$

wherein ΔL* is a difference between L* before the light resistance test and L* after the light resistance test, Δa* is a difference between a* after the light resistance test and a* before the light resistance test, and Δb* is a difference between b* after the light resistance test and b* before the light resistance test.

The light-transmitting substrate may include a polymer resin and a malonate-based UV absorber.

The UV absorber may have a maximum absorbance of 0.45 or more in a UVA region from 315 to 400 nm when dissolved at a concentration of 0.001 wt % in DMAc.

The ultraviolet absorber may include a compound represented by the following Formula 2:

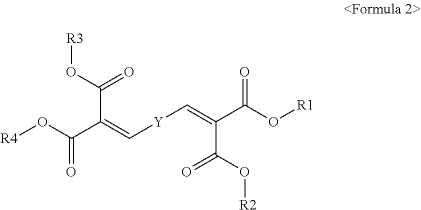

wherein R¹, R², R³ and R⁴ are each independently hydrogen, a halogen element, a phenyl group, or a C1-C10 linear, branched or alicyclic alkyl group, and Y is a C6-C40 divalent aromatic or heterocyclic organic group, wherein the hydrogen atom in the organic group included in Formula 2 is substituted by a halogen element, a hydrocarbon group, a halogen-substituted hydrocarbon group, or a halogen-, oxygen- or nitrogen-substituted hydrocarbon group.

The ultraviolet absorber may include tetraethyl 2,2′-(1,4-phenylenedimethylidyne)bismalonate.

The light-transmitting substrate may include 1 to 10 parts by weight of the ultraviolet absorber based on 100 parts by weight of the polymer resin.

The polymer resin may include at least one of an imide repeating unit or an amide repeating unit.

The optical film may have a light transmittance after the light resistance test of 88.5% or more and may have a haze after the light resistance test of 1.0 or less.

In accordance with another aspect of the present disclosure, provided is a display device including a display panel and the optical film disposed on the display panel.

### Advantageous Effects

One embodiment of the present disclosure provides an optical film that exhibits improved light resistance in a UVA region from 315 to 400 nm.

Another embodiment of the present disclosure provides a display device including the optical film that exhibits improved light resistance in a UVA region from 315 to 400 nm.

### DESCRIPTION OF DRAWINGS

FIG. 1 is a cross-sectional view illustrating an optical film 100 according to an embodiment of the present disclosure;

FIG. 2 is a cross-sectional view illustrating an optical film 101 further including a primer layer 120 according to another embodiment of the present disclosure;

FIG. 3 is a cross-sectional view illustrating an optical film 102 further including a hard coating layer 130 according to another embodiment of the present disclosure;

FIG. 4 is a cross-sectional view of a part of a display device 200 according to another embodiment of the present disclosure; and

FIG. 5 is an enlarged cross-sectional view illustrating part “P” of FIG. 4.

### BEST MODE

Hereinafter, embodiments of the present disclosure will be described in detail with reference to the accompanying drawings. However, the following embodiments are illustratively provided merely for clear understanding of the present disclosure, and do not limit the scope of the present disclosure.

The shapes, sizes, ratios, angles, and numbers disclosed in the drawings for describing embodiments of the present disclosure are merely examples, and the present disclosure is not limited to the illustrated details. Like reference numerals refer to like elements throughout the present specification. In the following description, when a detailed description of relevant known functions or configurations is determined to unnecessarily obscure important points of the present disclosure, the detailed description will be omitted.

In the case in which a term such as “comprise”, “have”, or “include” is used in the present specification, another part may also be present, unless “only” is also used. Terms in a singular form may include the plural meanings, unless noted to the contrary. Also, in construing an element, the element is to be construed as including an error range, even if there is no explicit description thereof.

In describing a positional relationship, for example, when the positional relationship is described using “on”, “above”, “below”, or “next to”, the case of no contact therebetween may be included, unless “just” or “directly” is used.

Spatially relative terms, such as “below”, “beneath”, “lower”, “above”, and “upper”, may be used herein to describe the relationship between a device or element and another device or element, as shown in the figures. It will be understood that spatially relative terms are intended to encompass different orientations of a device during the use or operation of the device, in addition to the orientation depicted in the figures. For example, if a device in one of the figures is turned upside down, elements described as “below” or “beneath” other elements would then be positioned “above” the other elements. The exemplary term “below” or “beneath” can, therefore, encompass the meanings of both “below” and “above”. In the same manner, the exemplary term “above” or “upper” can encompass the meanings of both “above” and “below”.

In describing temporal relationships, for example, when a temporal order is described using “after”, “subsequent”, “next”, or “before”, the case of a non-continuous relationship may be included, unless “just” or “directly” is used.

It will be understood that, although the terms “first”, “second”, etc. may be used herein to describe various elements, these elements are not limited by these terms. These terms are only used to distinguish one element from another. Therefore, a first element could be termed a second element within the technical idea of the present disclosure.

It should be understood that the term “at least one” includes all combinations related with one or more items. For example, “at least one among a first element, a second element, and a third element” may include all combinations of two or more elements selected from among the first, second, and third elements, as well as each of the first, second, and third elements.

Features of various embodiments of the present disclosure may be partially or completely integrated or combined with each other, and may be variously interoperated with each other and driven technically. The embodiments of the present disclosure may be carried out independently from each other, or may be carried out together in an interrelated manner.

Prior to the detailed description of the present disclosure below, it should be understood that the terminology used herein is provided only for describing specific embodiments, and is not limited only by the attached claims. All technical and scientific terms used herein have the same meanings as commonly understood by those skilled in the art, unless mentioned otherwise.

In addition, the terms or words used in the present specification and claims below are intended to be interpreted as having meanings and concepts consistent with the technical idea of the present disclosure as described in the present specification, and are not limited to common or dictionary meanings, based on the principle that the inventors can appropriately define the concept of a term in order to best describe the disclosure.

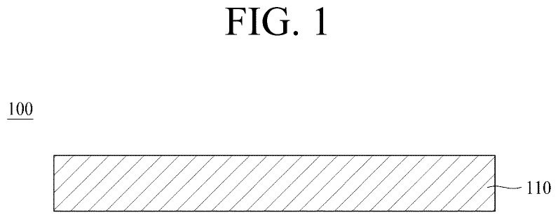

An embodiment of the present disclosure provides an optical film 100. FIG. 1 is a cross-sectional view illustrating the optical film 100 according to an embodiment of the present disclosure.

As shown in FIG. 1, the optical film 100 according to an embodiment of the present disclosure includes a light-transmitting substrate 110.

The optical film 100 according to an embodiment of the present disclosure has a yellowness index before the light resistance test of 5.0 or less and a color change (ΔE*_{ab}) after the light resistance test of 3.5 or less.

The yellowness index before the light resistance test may be measured using a spectrophotometer. Specifically, the yellowness index of the optical film may be measured in accordance with the ASTM E313 standard using a spectrophotometer, for example, CM-3700D from Konica Minolta, Inc.

The light resistance test is performed under the following conditions [daylight filter, 12 kW 0.8 W/m², @420 nm, 30° C./30 RH % chamber and 55° C. black panel] using a Xenon lamp for 300 hours, and the color change (ΔE*_{ab}) is calculated by the following Equation 1:

$$Δ {E}_{ab}^{*} = {[ {( Δ {L}^{*} )}^{2} + {( Δ {a}^{*} )}^{2} + {( Δ {b}^{*} )}^{2} ]}^{1 / 2} \qquad 〈 Equation 1 〉$$

wherein ΔL* is a difference between L* before the light resistance test and L* after the light resistance test, Δa* is a difference between a* after the light resistance test and a* before the light resistance test, and Δb* is a difference between b* after the light resistance test and b* before the light resistance test.

L*, a*, and b* before the light resistance test of the optical film 100 may be measured using a color difference meter. Specifically, L*, a*, and b* of the optical film 100 may be determined by measuring L*, a*, and b* three times using a color difference meter (model name: CM-3600A) from Konica Minolta, Inc. in a D65 light source at a viewing angle of 2° in a transmission mode and calculating an average of the measured three values of L*, a*, and b*. The L*, a*, and b* after the light resistance test may be measured in the same manner as in the method of measuring the L*, a*, and b* before the light resistance test after performing the light resistance test.

When the yellowness index before the light resistance test of the optical film 100 is 5.0 or less and the color change (ΔE*_{ab}) after the light resistance test is 3.5 or less, the optical film 100 has excellent visibility and light resistance, particularly UV light resistance, and is thus suitable for use as a cover window of a display device. Since the polymer resin included in the light-transmitting substrate 110 of the optical film 100 has a large number of aromatic rings, the optical film 100 changes color when exposed to light with an ultraviolet (UV) wavelength. Accordingly, color reproducibility and sharpness of the optical film 100 decrease over time and thus visibility decreases. On the other hand, even when the optical film 100 having excellent UV light resistance is exposed to light with an ultraviolet (UV) wavelength, it undergoes a small color change and thus the lifespan of the cover window of the display device may increase.

The light-transmitting substrate 110 of an embodiment of the present disclosure may include a polymer resin and a UV absorber.

The polymer resin is suitable for use as a cover window of a flexible display device due to the excellent flexural properties and impact resistance thereof. The polymer resin may be included in a film in various shapes and forms, such as a solid powder form, a form dissolved in a solution, a matrix form solidified after being dissolved in a solution, etc. Any resin containing the same repeating unit as the resin of the present disclosure may be considered the same as the polymer resin of the present disclosure, regardless of the shape and form thereof. In general, the polymer resin in the film may be present as a solidified matrix obtained by applying a polymer resin solution, followed by drying.

The polymer resin according to an embodiment of the present disclosure may be any light-transmitting resin. For example, the polymer resin may include at least one selected from cycloolefin-based derivatives, cellulose-based polymers, ethylene vinyl acetate-based copolymers, polyester-based polymers, polystyrene-based polymers, polyamide-based polymers, polyamide-imide-based polymers, polyetherimide-based polymers, polyacryl-based polymers, polyimide-based polymers, polyether sulfone-based polymers, polysulfone-based polymers, polyethylene-based polymers, polypropylene-based polymers, polymethylpentene-based polymers, polyvinyl chloride-based polymers, polyvinylidene chloride-based polymers, polyvinyl alcohol-based polymers, polyvinyl acetal-based polymers, polyether ketone-based polymers, polyether ether ketone-based polymers, polymethyl methacrylate-based polymers, polyethylene terephthalate-based polymers, polybutylene terephthalate-based polymers, polyethylene naphthalate-based polymers, polycarbonate-based polymers, polyurethane-based polymers, and epoxy-based polymers. Preferably, the polymer resin according to an embodiment of the present disclosure may include at least one of polyimide-based polymers, polyamide-based polymers, or polyamide-imide-based polymers. In particular, polyimide-based polymers, polyamide-based polymers, and polyamide-imide-based polymers exhibit excellent physical properties such as thermal properties, hardness, abrasion resistance, and flexibility, and superior optical properties such as light transmittance and haze. The light-transmitting substrate 110 of the optical film 100 used as a cover window preferably includes at least one of polyimide-based polymers, polyamide-based polymers, or polyamide-imide-based polymers, but the present disclosure is not limited thereto.

According to an embodiment of the present disclosure, the light-transmitting substrate 110 may include a polymer resin including at least one of an imide repeating unit or an amide repeating unit. As used herein, the term “imide repeating unit” refers to a repeating unit produced by reaction between a diamine-based compound and a dianhydride-based compound and imidization, and the term “amide repeating unit” refers to a repeat unit produced by reaction between a diamine-based compound and a dicarbonyl-based compound. The light-transmitting substrate 110 may be any one of polyimide-based substrates, polyamide-based substrates, and polyamide-imide-based substrates. However, the embodiments of the present disclosure are not limited thereto, and any substrate may be used as the light-transmitting substrate 110, as long as it is light-transmissive.

According to an embodiment of the present disclosure, the light-transmitting substrate 110 may include an ultraviolet absorber. The ultraviolet absorber may include a malonate compound. That is, the light-transmitting substrate 110 according to an embodiment of the present disclosure may include a malonate-based UV absorber.

The malonate-based compound of the present disclosure is a compound containing a malonate substituent and the malonate substituent has a structure represented by the following Formula 1. That is, the malonate-based compound refers to a compound having a structure represented by the following Formula 1.

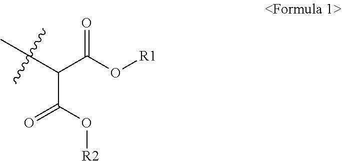

wherein R¹ and R² are each independently hydrogen, a halogen element, a phenyl group, or a C1-C10 linear, branched or alicyclic alkyl group.

The malonate compound minimizes an increase in the initial yellowness index of the optical film 100 and is highly effective in improving the light resistance of the optical film 100. When the optical film 100 includes the malonate compound as a UV absorber, it is capable of minimizing color change when exposed to light.

According to an embodiment of the present disclosure, when the UV absorber is dissolved at a concentration of 0.001 wt % in DMAc, the maximum absorbance in the UVA region (315 to 400 nm) may be 0.45 or more.

The maximum absorbance in the UVA region (315 to 400 nm) of the UV absorber may be measured using a UV spectrophotometer. Specifically, a UV absorber is dissolved at a concentration of 0.001 wt % in N,N-dimethylacetamide (DMAc), the maximum absorbance in the UVA region (315 to 400 nm) is measured using a UV spectrometer (model name: UV-1800) from Shimadzu Corporation, and the maximum value among the absorbance values measured in the UVA region (315-400 nm) is determined as the maximum absorbance in the UVA region (315-400 nm) of the ultraviolet absorber.

When the maximum absorbance of the UVA region from 315 to 400 nm of the ultraviolet absorber is 0.45 or more, it is possible to minimize the improvement of the initial yellowness index of the optical film 100 and to improve the light resistance to adjust the initial yellowness index to 5.0 or less and adjust the color change (ΔE*ab) after the light resistance test to 3.5 or less.

According to an embodiment of the present disclosure, the ultraviolet absorber may include at least two structures represented by Formula 1 above. That is, the ultraviolet absorber may include at least two malonate substituents.

When the ultraviolet absorber includes two or more malonate substituents, the absorbance of the ultraviolet absorber increases to adjust the maximum absorbance in the UVA region (315 to 400 nm) to 0.45 or more.

According to an embodiment of the present disclosure, the ultraviolet absorber may include a compound represented by the following Formula 2:

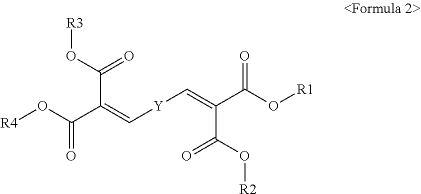

wherein R¹, R², R³ and R⁴ are each independently hydrogen, a halogen element, a phenyl group, or a C1-C10 linear, branched or alicyclic alkyl group, and Y is a C6-C40 divalent aromatic or heterocyclic organic group, wherein the hydrogen atom in the organic group included in Formula 2 is substituted by a halogen element, a hydrocarbon group, a halogen-substituted hydrocarbon group, or a halogen-, oxygen- or nitrogen-substituted hydrocarbon group.

In Formula 2, Y may include, for example, any one of the structural formulas represented by the following Formula 3:

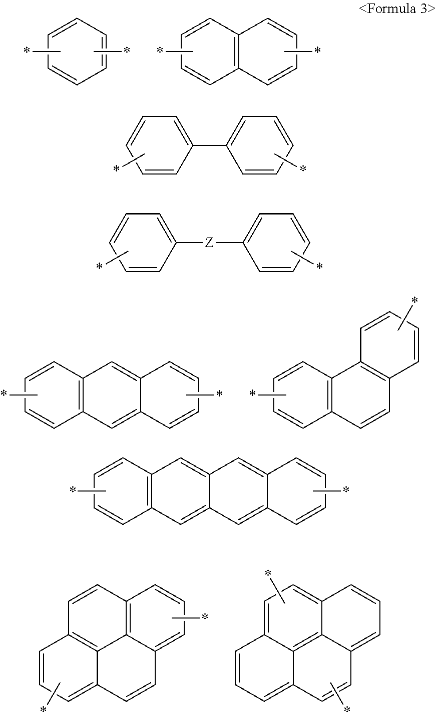

In the structural formulas of Formula 3, * represents a bonding position. In the structural formulas, Z is each independently any one of a single bond, O, S, SO₂, CO, and (C═C)ₙ, and n is an integer of 1 to 5. Although the bonding position of Z on each ring is not particularly limited, the bonding position of Z may be, for example, a meta or para position on each ring. The hydrogen atom in the structural formulas of Formula 3 may be substituted with a halogen element, a hydrocarbon group, a halogen-substituted hydrocarbon group, or a halogen-, oxygen- or nitrogen-substituted hydrocarbon group. In Formula 3, each structural formula may be a heterocyclic organic group in which at least one carbon in the structural formula is substituted with an element such as nitrogen (N), sulfur (S), or oxygen (O).

According to an embodiment of the present disclosure, the ultraviolet absorbent may include tetraethyl 2,2′-(1,4-phenylenedimethylidyne)bismalonate.

According to an embodiment of the present disclosure, the light-transmitting substrate may include 1 to 10 parts by weight of the ultraviolet absorber based on 100 parts by weight of the polymer resin.

When the UV absorber is present in an amount of less than 1 part by weight with respect to 100 parts by weight of the polymer resin, the effect of improving light resistance is insufficient and thus the color change (ΔE*ab) after the light resistance test is higher than 3.5. On the other hand, when the UV absorber is present in an amount of more than 10 parts by weight with respect to 100 parts by weight of the polymer resin, the initial yellowness index before the light resistance test is higher than 5.0 and the problem of dissolution may occur during long-term storage.

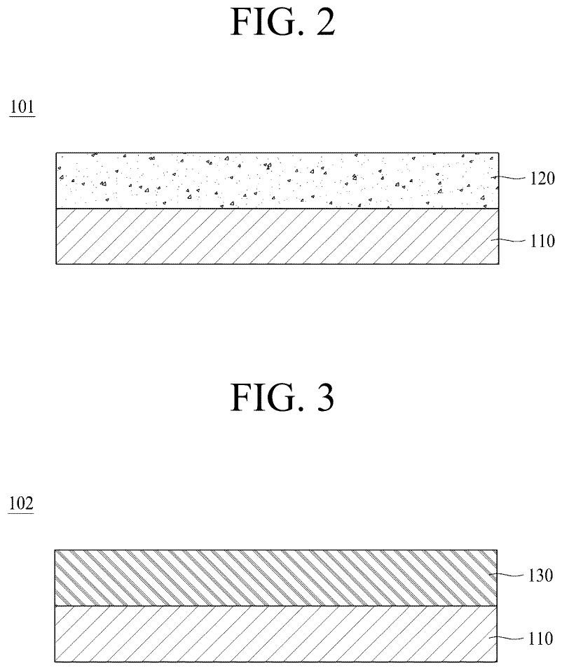

According to an embodiment of the present disclosure, the optical film 101 may further include a primer layer 120 on the light-transmitting substrate 110. FIG. 2 is a cross-sectional view illustrating an optical film 101 further including a primer layer 120.

As shown in FIG. 2, the optical film 101 further including the primer layer 120 may have a structure in which the light-transmitting substrate 110 and the primer layer 120 are laminated in this order.

The primer layer 120 of the present disclosure may include a curable resin.

According to an embodiment of the present disclosure, the curable resin may include at least one selected from an acryl-based resin, a urethane-based resin, and a siloxane-based resin.

According to an embodiment of the present disclosure, the primer layer 120 of the present disclosure may further include at least one of a UV absorber or a pigment.

According to an embodiment of the present disclosure, the primer layer 120 may include the same malonate-based UV absorber as in the light-transmitting substrate 110, or may include a UV absorber other than the malonate-based UV absorber. The present disclosure is not limited thereto.

According to an embodiment of the present disclosure, the pigment may include a copper-phthalocyanine-based compound. However, the present disclosure is not limited thereto and pigments other than the copper-phthalocyanine-based compound may also be used.

According to an embodiment of the present disclosure, the primer layer 120 may have a thickness of 0.1 to 10 μm. Preferably, the primer layer 120 may have a thickness of 1 to 5 μm. However, the present disclosure is not limited thereto.

According to an embodiment of the present disclosure, the optical film 102 may further include a hard coating layer 130 on the light-transmitting substrate 110. FIG. 3 is a cross-sectional view illustrating an optical film 102 further including a hard coating layer 130.

As shown in FIG. 3, the optical film 102 further including the hard coating layer 130 may have a structure in which the light-transmitting substrate 110 and the hard coating layer 130 are laminated in this order.

The hard coating layer 130 is a layer that protects the adherend, to which the optical film 102 or the optical film 101 is attached, from the external environment. According to an embodiment of the present disclosure, the hard coating layer 130 may include at least one of a siloxane-based resin, an acryl-based resin, a urethane-based resin, or an epoxy-based resin.

According to an embodiment of the present disclosure, the hard coating layer 130 may have a thickness of 1 to 10 μm, preferably a thickness of 1 to 5 μm. However, the present disclosure is not limited thereto.

According to an embodiment of the present disclosure, the optical film may include both the primer layer 120 and the hard coating layer 130 on the light-transmitting substrate 110 (not shown in the drawing). The optical film further including the primer layer 120 and the hard coating layer 130 may have a structure in which the light-transmitting substrate 110, the primer layer 120, and the hard coating layer 130 are laminated in this order.

According to an embodiment of the present disclosure, the optical film 100 may be light-transmissive and flexible. For example, the optical film according to an embodiment of the present disclosure may be bendable, foldable and rollable.

According to an embodiment of the present disclosure, the optical film 100 may have a light transmittance after the light resistance test of 88.5% or more and a haze before the light resistance test of 0.4 or less.

Light transmittance before light resistance test of the optical film may be measured in a wavelength range from 360 to 740 nm using a spectrophotometer, for example, a spectrophotometer from Konica Minolta, Inc. Model CM-3700D in accordance with ASTM E313.

The haze before light resistance test of the produced optical film is measured by cutting the optical film into a specimen with a size of 50 mm×50 mm, measuring a haze of the specimen 3 times using a haze meter, for example, a haze meter from Murakami Color Laboratories (model name: HM-150) in accordance with ASTM D1003, and calculating an average of the measured three haze values.

According to an embodiment of the present disclosure, the optical film 100 may have a light transmittance after the light resistance test of 88.5% or more and a haze before the light resistance test of 1.0 or less.

The light transmittance and haze after the light resistance test may be measured in the same manner as in the method of measuring the light transmittance and haze before the light resistance test, after performing the light resistance test.

The optical film 100 according to an embodiment of the present disclosure may be applied to a display device to protect the display surface of the display panel. The optical film 100 according to an embodiment of the present disclosure may have a thickness sufficient to protect the display panel. For example, the optical film 100 may have a thickness of 20 to 120 μm, but the present disclosure is not limited thereto.

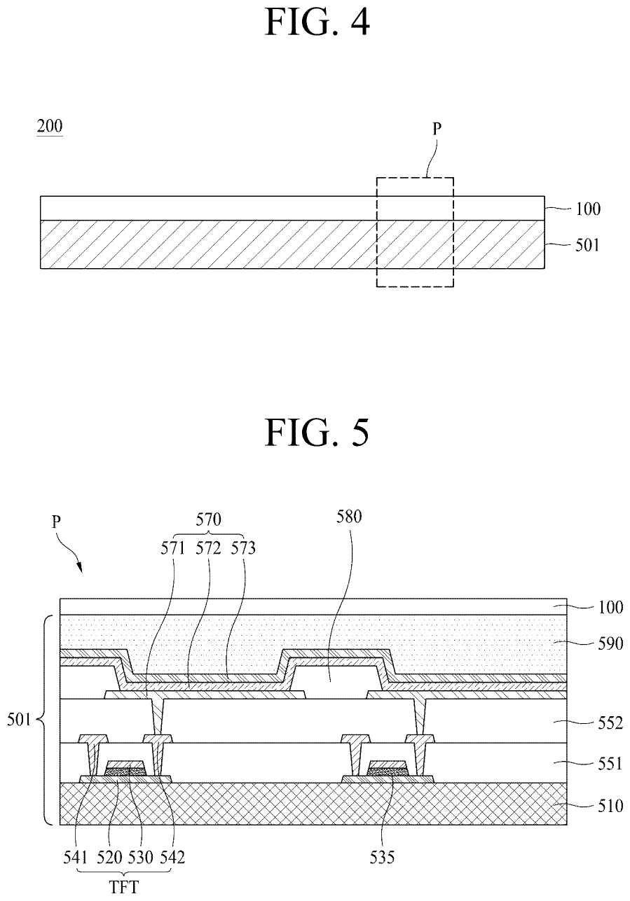

Hereinafter, a display device including the optical film 100 according to an embodiment of the present disclosure will be described with reference to FIGS. 4 and 5.

FIG. 4 is a cross-sectional view illustrating a part of a display device 200 according to another embodiment of the present disclosure and FIG. 5 is an enlarged cross-sectional view of “P” in FIG. 4.

Referring to FIG. 4, the display device 200 according to another embodiment of the present disclosure includes a display panel 501 and an optical film 100 on the display panel 501. The optical film 100 of FIG. 4 may be the optical film 101 of FIG. 2 or the optical film 102 of FIG. 3.

Referring to FIGS. 4 and 5, the display panel 501 includes a substrate 510, a thin film transistor TFT on the substrate 510, and an organic light-emitting device 570 connected to the thin film transistor TFT. The organic light-emitting device 570 includes a first electrode 571, an organic light-emitting layer 572 on the first electrode 571, and a second electrode 573 on the organic light-emitting layer 572. The display device 200 shown in FIGS. 4 and 5 is an organic light-emitting display device.

The substrate 510 may be formed of glass or plastic. Specifically, the substrate 510 may be formed of plastic such as a polymer resin. Although not shown, a buffer layer may be disposed on the substrate 510.

The thin film transistor TFT is disposed on the substrate 510. The thin film transistor TFT includes a semiconductor layer 520, a gate electrode 530 that is insulated from the semiconductor layer 520 and at least partially overlaps the semiconductor layer 520, a source electrode 541 connected to the semiconductor layer 520, and a drain electrode 542 that is spaced apart from the source electrode 541 and is connected to the semiconductor layer 520.

Referring to FIG. 5, a gate insulating layer 535 is disposed between the gate electrode 530 and the semiconductor layer 520. An interlayer insulating layer 551 may be disposed on the gate electrode 530, and a source electrode 541 and a drain electrode 542 may be disposed on the interlayer insulating layer 551.

A planarization layer 552 is disposed on the thin film transistor TFT to planarize the top of the thin film transistor TFT.

A first electrode 571 is disposed on the planarization layer 552. The first electrode 571 is connected to the thin film transistor TFT through a contact hole provided in the planarization layer 552.

A bank layer 580 is disposed on the planarization layer 552 in a part of the first electrode 571 to define pixel areas or light-emitting areas. For example, the bank layer 580 is disposed in the form of a matrix at the boundaries between a plurality of pixels to define the respective pixel regions.

The organic light-emitting layer 572 is disposed on the first electrode 571. The organic light-emitting layer 572 may also be disposed on the bank layer 580. The organic light-emitting layer 572 may include one light-emitting layer, or two or more light-emitting layers stacked in a vertical direction. Light having any one color among red, green, and blue may be emitted from the organic light-emitting layer 572, and white light may be emitted therefrom.

The second electrode 573 is disposed on the organic light-emitting layer 572.

The first electrode 571, the organic light-emitting layer 572, and the second electrode 573 may be stacked to constitute the organic light-emitting device 570.

Although not shown, when the organic light-emitting layer 572 emits white light, each pixel may include a color filter for filtering the white light emitted from the organic light-emitting layer 572 based on a particular wavelength. The color filter is formed in the light path.

A thin-film encapsulation layer 590 may be disposed on the second electrode 573. The thin-film encapsulation layer 590 may include at least one organic layer and at least one inorganic layer, and the at least one organic layer and the at least one inorganic layer may be alternately disposed.

The optical film 100 is disposed on the display panel 501 having the stack structure described above.

Hereinafter, the present disclosure will be described in more detail with reference to examples and comparative examples. However, the following examples and comparative examples should not be construed as limiting the scope of the present disclosure.

### Preparation Example: Preparation of Polymer Resin

776.655 g of N,N-dimethylacetamide (DMAc) was charged in a 1 L reactor equipped with a stirrer, a nitrogen injector, a dropping funnel, a temperature controller, and a cooler while the reactor was purged with nitrogen. Then, the temperature of the reactor was adjusted to 25° C., 54.439 g (0.17 mol) of bis(trifluoromethyl)benzidine (TFDB) was dissolved therein, and the temperature of the solution was maintained at 25° C. 15.005 g (0.051 mol) of biphenyl-tetracarboxylic acid dianhydride (BPDA) was further added thereto and completely dissolved therein by stirring for 3 hours and 22.657 g (0.051 mol) of 4,4′-(hexafluoroisopropylidene)diphthalic anhydride (6FDA) was further added thereto and completely dissolved therein. The reactor temperature was lowered to 10° C., and 13.805 g (0.068 mol) of terephthaloyl chloride (TPC) was further added thereto and allowed to react at 25° C. for 12 hours to obtain a polymer solution having a solid content of 12 wt %.

17.75 g of pyridine and 22.92 g of acetic anhydride were added to the obtained polymer solution, stirred for 30 minutes, stirred again for 1 hour at 70° C., and allowed to cool to room temperature. 20 L of methanol was added to the obtained polymer solution to precipitate a solid and the precipitated solid was filtered, pulverized, washed with 2 L of methanol, and dried under vacuum at 100° C. for 6 hours to prepare a polyimide-based polymer solid as a powder. The prepared polyimide-based polymer solid was a polyamide-imide polymer solid.

### EXAMPLE 1

300 parts by weight of DMAc and 2 parts by weight of tetraethyl 2,2′-(1,4-phenylenedimethylidyne)bismalonate (ultraviolet absorbent, Cas No.: 6337-43-5, Eversorb 320 from Chempia Co., Ltd.), with respect to 100 parts by weight of the polyamide-imide polymer solid, were added to a 500 mL reactor, and sufficiently dissolved at room temperature for 10 minutes, and the reactor was stirred while maintaining the temperature at 5° C. Then, 43.72 parts by weight of a polyimide-based polymer solid powder prepared in Preparation Example was added thereto and stirred for 1 hour, and the resulting mixture was warmed to 25° C. to prepare a polyimide-based resin solution. The maximum absorbance of tetraethyl 2,2′-(1,4-phenylenedimethylidyne)bismalonate was 0.95 (@321 nm).

The obtained polyimide-based resin solution was applied onto a casting substrate, cast and dried with hot air at 130° C. for 30 minutes to produce a film. Then, the produced film was peeled off of the casting substrate and fixed to a frame with pins. At this time, there is no particular limitation on the type of the casting substrate. The casting substrate may be a glass substrate, a stainless steel (SUS) substrate, a Teflon substrate, or the like. In Example 1, an organic substrate was used as a casting substrate. The same applies hereinbelow.

The frame to which the optical film was fixed was slowly heated in a vacuum oven from 100° C. to 280° C. for 2 hours, cooled slowly and separated from the frame to obtain a polyimide-based optical film. The polyimide-based optical film was heated again at 250° C. for 5 minutes. As a result, a polyimide-based optical film having a thickness of 50 μm was completed.

### EXAMPLE 2

The optical film of Example 2 was produced in the same manner as in Example 1, except that the content of ultraviolet absorber was changed.

Details on the content of ultraviolet absorber in Example 2 are shown in Table 1 below.

### Comparative Examples 1 to 4

Optical films of Comparative Examples 1 to 4 were produced in the same manner as in Example 1, except that the types and contents of ultraviolet absorbers were changed.

Details on the types and contents of ultraviolet absorbers in Comparative Examples 1 to 4 are shown in Table 1 below.

At this time, the maximum absorbance in the UVA region (315 to 400 nm) of the ultraviolet absorber was obtained by dissolving each ultraviolet absorber at 0.001 wt % in DMAc, measuring an absorbance using an ultraviolet spectrometer from Shimadzu (UV spectrophotometer UV-1800) in the UVA region (315-400 nm), and determining the maximum value among the absorbance values measured in the UVA region (315-400 nm) as the maximum absorbance in the UVA region (315-400 nm) of the UV absorber.

TABLE 1

| | | Maximum | Content of | | |
|---|---|---|---|---|---|
| | | absorbance of | polyimide-based | Content of | |
| | | UV absorber in | polymer solid | UV absorber | Thickness |
| Item | UV absorber | UVA region | (parts by weight) | (parts by weight) | (μm) |
| Example 1 | Tetraethyl 2,2′-(1,4- | 0.95 | 100 | 2 | 50 |
| | phenylenedimethylidyne) | (@321 nm) | | | |
| | bismalonate | | | | |
| Example 2 | Tetraethyl 2,2′-(1,4- | 0.95 | 100 | 4 | 50 |
| | phenylenedimethylidyne) | (@321 nm) | | | |
| | bismalonate | | | | |
| Comparative | — | — | 100 | 0 | 50 |
| Example 1 | | | | | |
| Comparative | 2-(2H-benzotriazol-2- | 0.32 | 100 | 3 | 50 |
| Example 2 | y1)-4-(1,1,3,3- | (@333 nm) | | | |
| | tetramethylbutyl ) phenol | | | | |
| Comparative | 2-(2H-benzotriazol-2- | 0.32 | 100 | 4 | 50 |
| Example 3 | y1)-4-(1,1,3,3- | (@333 nm) | | | |
| | tetramethylbutyl ) phenol | | | | |
| Comparative | 2-tert-Butyl-6-(5- | 0.43 | 100 | 1 | 50 |
| Example 4 | chloro-2H-benzotriazol- | (@349 nm) | | | |
| | 2-yl)-4-methylphnol | | | | |

### Measurement Example

The following measurements were performed on the optical films produced in Examples 1 to 2 and Comparative Examples 1 to 4. In the following Measurement Example, measurement was performed before the light resistance test and was then performed again after the light resistance test.

The light resistance test was performed for 300 hours under the conditions of Daylight filter, 12 kW 0.8 W/m² @420 nm, 30° C./30 RH % chamber, 55° C. black panel using a Xenon Lamp, specifically, SUNTEST XXL+ from ATLAS.

### 1) Yellowness Index (Y.I.)

Specifically, the yellowness index was measured using a spectrophotometer. Specifically, the yellowness index of the optical film was measured in accordance with ASTM E313 using a spectrophotometer, for example, a spectrophotometer from Konica Minolta, Inc. (model name: CM-3700D).

### 2) L*, a*, b* and Color Change (ΔE*_{ab})

The color change (ΔE*_{ab}) of optical films produced according to Examples and Comparative Examples was calculated in accordance with the following Equation 1:

$$Δ {E}_{ab}^{*} = {[ {( Δ {L}^{*} )}^{2} + {( Δ {a}^{*} )}^{2} + {( Δ {b}^{*} )}^{2} ]}^{1 / 2} \qquad 〈 Equation 1 〉$$

wherein ΔL* is the difference between L* after the light resistance test and L* before the light resistance test, Δa* is the difference between a* after the light resistance test and a* before the light resistance test, and Δb* is the difference between b* after the light resistance test and b* before the light resistance test.

L*, a*, and b* before the light resistance test of the optical film 100 may be measured using a colorimeter. Specifically, L*, a*, and b* of the optical film 100 may be obtained by measuring L*, a*, and b* three times using a color difference meter, for example, a color difference meter from Konica Minolta, Inc. (model name: CM-3600A) in a D65 light source at a viewing angle of 2° in a transmission mode, and calculating an average of the measured three L*, a*, and b* values. The L*, a*, and b* after the light resistance test may be measured in the same manner as in the method of measuring the L*, a*, and b* before the light resistance test after performing the light resistance test.

### 3) Light Transmittance

The average light transmittance of each of the optical films produced according to Examples and Comparative Examples was measured in a wavelength range from 360 to 740 nm using a spectrophotometer, for example, a spectrophotometer from Konica Minolta, Inc. using a spectrophotometer (CM-3700D) in accordance with ASTM E313.

### 4) Haze

The haze of each of the optical films produced according to Examples and Comparative Examples was obtained by cutting the optical film into a specimen with a size of 50 mm×50 mm, measuring a haze of the specimen 5 times using a haze meter, for example, a haze meter from Murakami Color Laboratories (model name: HM-150) in accordance with ASTM D1003, and calculating an average of the five haze values.

The results of measurement are shown in the following Tables 2 and 3.

TABLE 2

| | Before light resistance test | | | | | |
|---|---|---|---|---|---|---|
| | | L* | a* | b* | Light | |
| Item | Y.I. | (D65) | (D65) | (D65) | transmittance | Haze |
| Example 1 | 2.9 | 95.6 | −0.7 | 2.3 | 89.0 | 0.2 |
| Example 2 | 3.3 | 95.6 | −0.8 | 2.5 | 89.0 | 0.2 |
| Comparative | 2.6 | 95.6 | −0.7 | 2.1 | 89.1 | 0.1 |
| Example 1 | | | | | | |
| Comparative | 3.3 | 95.6 | −0.9 | 2.6 | 88.9 | 0.2 |
| Example 2 | | | | | | |
| Comparative | 3.4 | 95.6 | −1.0 | 2.7 | 89.0 | 0.1 |
| Example 3 | | | | | | |
| Comparative | 5.1 | 95.5 | −1.1 | 3.2 | 88.9 | 0.2 |
| Example 4 | | | | | | |

TABLE 3

| | After light resistance test | | | | | | |
|---|---|---|---|---|---|---|---|
| | | L* | a* | b* | Light | | |
| Item | Y.I. | (D65) | (D65) | (D65) | transmittance | Haze | ΔE*_{ab} |
| Example 1 | 7.8 | 95.8 | −1.7 | 5.7 | 89.5 | 0.7 | 3.5 |
| Example 2 | 7.1 | 95.8 | −1.5 | 5.1 | 89.6 | 0.7 | 2.7 |
| Comparative | 9.0 | 95.7 | −1.9 | 6.5 | 89.2 | 0.8 | 4.6 |
| Example 1 | | | | | | | |
| Comparative | 8.8 | 95.7 | −1.9 | 6.4 | 89.4 | 0.8 | 3.9 |
| Example 2 | | | | | | | |
| Comparative | 8.9 | 95.7 | −1.9 | 6.5 | 89.3 | 0.7 | 3.9 |
| Example 3 | | | | | | | |
| Comparative | 9.5 | 95.6 | −2.1 | 7.0 | 89.1 | 1.1 | 3.9 |
| Example 4 | | | | | | | |

As can be seen from the results of measurement of Tables 2 and 3, all of the optical films of Examples 1 and 2 of the present disclosure had a yellowness index before the light resistance test of 5.0 or less, a yellowness index after the light resistance test of 7.8 or less, a light transmittance of 88.5% or more, a haze of 1.0 or less, and ΔE*ab of 3.5 or less.

However, regarding the optical films of Comparative Examples 1 to 4, the optical films of Comparative Examples 1 to 3 had ΔE*_{ab} after the light resistance test higher than 3.5, and exhibited decreased color reproducibility and sharpness and thus low visibility. The optical film of Comparative Example 4 had an initial yellowness index before the light resistance test of higher than 5.0, a haze after the light fastness test of higher than 1.0, and ΔE*_{ab} of higher than 3.5, and thus exhibited high initial yellowness index and low visibility due to the decreased color reproducibility and sharpness after the light resistance test.

The features, structures, effects, and the like described in each of the above-described embodiments may be combined or modified into other embodiments by those skilled in the art to which the embodiments pertain. Accordingly, content relating to such combinations and modifications should be interpreted as falling within the scope of the present disclosure.

1. An optical film comprising a light-transmitting substrate, the optical film having a yellowness index before a light resistance test of 5.0 or less and a color change (ΔE*_{ab}) after the light resistance test of 3.5 or less,
wherein the light resistance test is performed under the following conditions [daylight filter, 12 kW, 0.8 W/m², @420 nm, 30° C./30 RH % chamber and 55° C. black panel] using a Xenon lamp for 300 hours, and the color change (ΔE*_{ab}) is calculated by the following Equation 1:
$$Δ {E}_{ab}^{*} = {[ {( Δ {L}^{*} )}^{2} + {( Δ {a}^{*} )}^{2} + {( Δ {b}^{*} )}^{2} ]}^{1 / 2} \qquad 〈 Equation 1 〉$$
wherein ΔL* is a difference between L* before the light resistance test and L* after the light resistance test, Δa* is a difference between a* after the light resistance test and a* before the light resistance test, and Δb* is a difference between b* after the light resistance test and b* before the light resistance test.

2. The optical film according to claim 1, wherein the light-transmitting substrate comprises:
a polymer resin; and
a malonate-based UV absorber.

3. The optical film according to claim 2, wherein the UV absorber has a maximum absorbance of 0.45 or more in a UVA region from 315 to 400 nm when dissolved at a concentration of 0.001 wt % in DMAc.

4. The optical film according to claim 2, wherein the ultraviolet absorber comprises a compound represented by the following Formula 2: 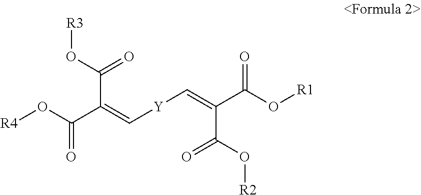
wherein R¹, R², R³ and R⁴ are each independently hydrogen, a halogen element, a phenyl group, or a C1-C10 linear, branched or alicyclic alkyl group; and
Y is a C6-C40 divalent aromatic or heterocyclic organic group,
wherein the hydrogen atom in the organic group included in Formula 2 is substituted by a halogen element, a hydrocarbon group, a halogen-substituted hydrocarbon group, or a halogen-, oxygen- or nitrogen-substituted hydrocarbon group.

5. The optical film according to claim 2, wherein the ultraviolet absorber comprises tetraethyl 2,2′-(1,4-phenylenedimethylidyne)bismalonate.

6. The optical film according to claim 2, wherein the light-transmitting substrate comprises 1 to 10 parts by weight of the ultraviolet absorber, based on 100 parts by weight of the polymer resin.

7. The optical film according to claim 2, wherein the polymer resin comprises at least one of an imide repeating unit or an amide repeating unit.

8. The optical film according to claim 1, wherein the optical film has a light transmittance after the light resistance test of 88.5% or more and a haze after the light resistance test of 1.0 or less.

9. A display device comprising:
a display panel; and
the optical film according to claim 1 disposed on the display panel.
